(19) United States
(12) Patent Application Publication
(10) Pub. No.: US 2008/0296121 A1
(43) Pub. Date: Dec. 4, 2008

(54) LUBRICATION CONTROLLING METHOD AND LUBRICATION CONTROLLING APPARATUS FOR STARTING CLUTCH OF UNIT TYPE

(75) Inventors: Tomoyuki MIYAZAKI, Fukuroi-shi (JP); Shun Kitahara, Fukuroi-shi (JP); Manabu Sawayanagi, Fukuroi-shi (JP); Masaki Sakai, Fukuroi-shi (JP); Yosuke Ikeda, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 12/121,746

(22) Filed: May 15, 2008

(30) Foreign Application Priority Data
May 23, 2007 (JP) 2007-136931

(51) Int. Cl. F16D 13/74

(52) U.S. Cl. 192/113.3

(57) ABSTRACT

The present invention provides a lubrication controlling method for a starting clutch disposed between a transmission and an engine of a vehicle and having a wet type multi-plate clutch for transmitting a power, the method comprising the steps of detecting a temperature of oil in the starting clutch by means of a first temperature sensor, and controlling a flow amount of lubricant oil of the starting clutch in accordance with the temperature of the oil detected by the first temperature sensor, regardless of a running condition of the vehicle, and wherein the controlling step is performed in such a manner that, if the temperature of the oil is below a first set value, the flow amount is minimized, and, if the temperature of the oil is above a second set value, the flow amount is maximized, and, if the temperature of the oil is between the first and second set values, the flow amount of the lubricant oil is continuously changed in accordance with the temperature of the oil.

### BACKGROUND OF THE INVENTION

1. Field of the Invention

The present invention relates to a lubrication controlling method and a lubrication controlling apparatus for a starting clutch of unit type which can be fitted to a torque converter of an automobile and the like.

2. Related Background Art

Conventionally, in automatic transmissions, the starting of a vehicle was performed by torque transmitting through a torque converter. The torque converter was mounted to many automatic vehicles since the torque converter has a torque amplifying effect and provides smooth torque transmission.

On the other hand, the torque converter has a disadvantage that a large amount of slip is generated during the torque transmission and, thus, the torque converter has less efficiency.

Therefore, in recent years, there has been proposed a technique in which a starting clutch is used in place of the torque converter, and the torque has been amplified at a low speed range by reducing a gear ratio and by increasing the number of speed change stages.

In general, the starting clutch includes a wet type multi-plate clutch housed in a clutch case. In the multi-plate clutch, friction plates as friction engaging elements at an output side and separator plates as friction engaging elements at an input side are arranged alternately along an axial direction. With this arrangement, a power is transmitted by engaging the friction plates with the separator plates by means of a piston.

In the starting clutch, particularly when the vehicle is running under a traffic crowded condition, since engagement and disengagement of the clutch are repeated frequently thereby to accumulate heat in the clutch portion, it is required to supply a large amount of lubricant oil. However, power loss of a pump for supplying the large amount of lubricant oil becomes great, which result in a bad influence upon reduction of fuel consumption.

In the wet type starting clutch, when the vehicle begins to start, i.e. when the wet type multi-plate clutch is engaged, a maximum amount of heat is generated. Conventionally, in order to cool such heat, a large amount (10 litters/min or more) of the lubricant oil was always supplied. In the wet type multi-plate clutch, the lubricant oil is required to be supplied to perform the cooling upon the engagement of the clutch and the lubricant oil is also required to cool the heated clutch having a high temperature during an idle rotation of the clutch. In general, during the engagement of the clutch, since the lubricant oil is hard to be flown between the plates of the clutch, even if the lubricant oil is flown, the clutch is hard to be cooled.

To address such a problem, for example, Japanese Patent Application Laid-open No. 2004-324818 discloses a technique in which the lubricant oil is supplied in accordance with a condition of the vehicle by using an electronic hydraulic solenoid. However, in this technique, the large amount of the lubricant oil is supplied to the clutch in a slipping condition of the clutch, and, if the engagement and disengagement of the clutch are repeated frequently, adequate cooling cannot be achieved. Further, there has not been proposed an idea in which an oil temperature in the starting clutch is measured and an amount of lubricant oil is properly adjusted in accordance with the measured result.

### SUMMARY OF THE INVENTION

Accordingly, an object of the present invention is to control a flow amount of lubricant oil in accordance with a temperature detected by a temperature sensor for detecting a temperature of oil in a starting clutch, thereby reducing power loss and preventing seizure of the clutch.

To achieve the above object, the present invention provides a lubrication controlling method for a starting clutch disposed between a transmission and an engine of a vehicle and having a wet type multi-plate clutch for transmitting power, the method comprising the steps of detecting a temperature of oil in the starting clutch by means of a first temperature sensor, and controlling a flow amount of lubricant oil of the starting clutch in accordance with the temperature of the oil detected by the first temperature sensor, regardless of a running condition of the vehicle, and wherein the controlling step is performed in such a manner that, if the temperature of the oil is below a first set value, the flow amount is minimized, and, if the temperature of the oil is above a second set value, the flow amount is maximized, and, if the temperature of the oil is between the first and second set values, the flow amount of the lubricant oil is continuously changed in accordance with the temperature of the oil.

Further, to achieve the above object, the present invention provides a lubrication controlling apparatus for a starting clutch disposed between a transmission and an engine of a vehicle and having a wet type multi-plate clutch for transmitting power, the apparatus comprising a first temperature sensor for detecting a temperature of oil in the starting clutch, and control means for controlling a flow amount of lubricant oil of the starting clutch in accordance with the temperature of the oil detected by the first temperature sensor, regardless of a running condition of the vehicle, and wherein the control means performs the control in such a manner that, if the temperature of the oil is below a first set value, the flow amount is minimized, and, if the temperature of the oil is above a second set value, the flow amount is maximized, and, if the temperature of the oil is between the first and second set values, the flow amount of the lubricant oil is continuously changed in accordance with the temperature of the oil.

According to the lubrication controlling method and apparatus for the starting clutch of the present invention, the following effects can be achieved.

Since the lubrication flow amount of the lubricant oil can be changed in accordance with the temperature condition of the starting clutch, if great heat is generated by the clutch, a much amount of the lubricant oil can be flown, thereby cooling the starting clutch effectively without excessive power loss of a pump for supplying the lubricant oil.

By providing the temperature sensor, the temperature of the lubricant oil can be detected and monitored accurately. Accordingly, in accordance with an output of the temperature sensor, the flow amount of the flow amount of the lubricant oil can be set with higher accuracy. Further, when the temperature of the oil is between the first set value and the second set value, since the flow amount of the lubricant oil is changed continuously in accordance with the temperature of the oil, the efficient lubrication control can be achieved.

Further, when the vehicle is running, since the starting clutch is normally maintained in an engagement condition without any slip, the starting clutch does not generate the heat, but is hard to be cooled. However, according to the present invention, since the lubricant oil is always flown in accordance with the temperature of the starting clutch to cool the clutch even during the engagement, if the engagement and disengagement of the clutch are repeated frequently, the clutch can be cooled adequately.

Further, when grooves are formed in friction materials of the clutch, the cooling effect is enhanced even during the engagement of the starting clutch.

Further features of the present invention will become apparent from the following description of exemplary embodiments with reference to the attached drawings.

### BRIEF DESCRIPTION OF THE DRAWINGS

FIG. 1 is an axial sectional view of a starting clutch, for explaining an embodiment of a lubrication controlling apparatus for the starting clutch according to the present invention; and

FIG. 2 is a graph showing a relationship between a temperature and an amount of lubricant oil in the starting clutch.

### DETAILED DESCRIPTION OF THE INVENTION

Now, an embodiment of the present invention will be fully explained with reference to the accompanying drawings. Incidentally, it should be noted that the embodiment described hereinbelow is merely an example of the present invention and that various alterations can be made.

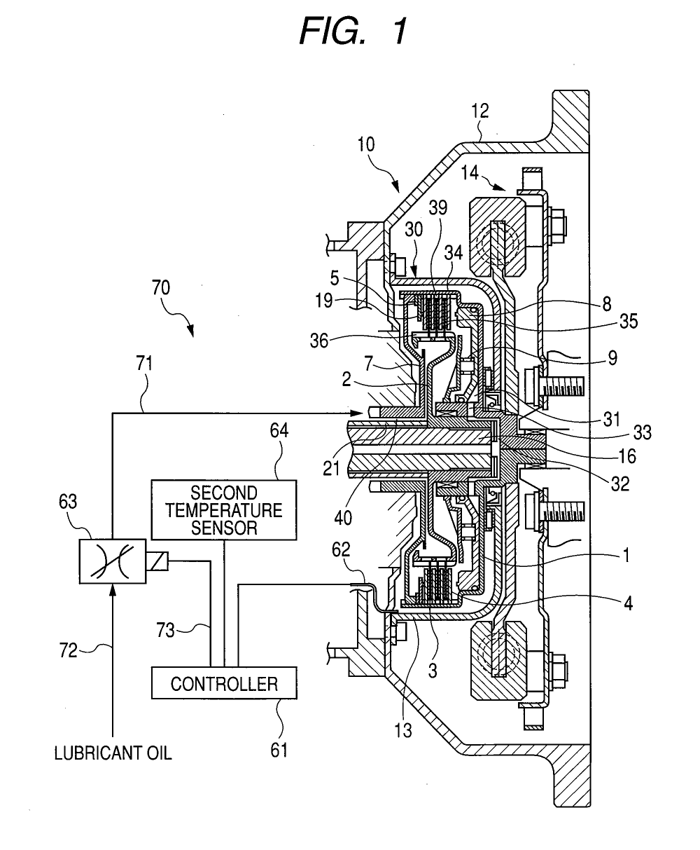

FIG. 1 is an axial sectional view of a starting clutch, for explaining an embodiment of a lubrication controlling apparatus for the starting clutch according to the present invention. A starting clutch 10 includes a clutch drum or clutch case 1 and a wet type multi-plate clutch 30 housed in the clutch case. Within the clutch case 1 of the wet type multi-plate clutch 30, substantially annular friction plates 3 as friction engaging elements at an output side and substantially annular separator plates 4 as friction engaging elements at an input side are arranged alternately along an axial direction. At an axial one end (open end) of the clutch case 1, a substantially annular backing plate 19 is fixedly supported by a substantially annular stop ring 5 in the axial direction, thereby holding the separator plate 4.

The annular clutch case 1 is provided at its outer periphery with a drum portion 34. The drum portion 34 is provided at its inner periphery with a spline portion 39 with which the separator plates 4 are engaged for an axial sliding movement.

In the illustrated embodiment, although the wet type multi-plate clutch 30 is constituted by three friction plates 3 and three separator plates 4, it should be noted that the number of the input and output side friction engaging elements can be changed voluntarily in accordance with required torque. Further, substantially annular friction materials 35 or plural friction material segments 35 are secured to axial both surfaces of the friction plate 3 by an adhesive or the like. Further, the friction materials 35 may be secured to the separator plates 4 or the friction materials 35 may be secured to one of surfaces of the friction plate 3 and the separator plate 4 alternately.

In FIG. 1, a piston 8 is provided within a closed end portion of the clutch case 1. The piston 8 is mounted within the clutch case 1 for an axial movement so that the piston can abut against the separator plate 4 to apply an urging force to the separator plate.

A hydraulic chamber 31 is defined between the piston 8 and an inner surface of the clutch case 1, which hydraulic chamber is maintained in an oil-tight condition by two O-rings. By supplying hydraulic oil from an oil path (described later) to the hydraulic chamber 31, the shifting movement of the piston 8 is controlled, thereby obtaining a predetermined urging force and applying the predetermined urging force to the piston 8. A spring 9 for always biasing the piston 8 toward the hydraulic chamber 31 in a clutch released condition is provided at a side of the piston opposite to the hydraulic chamber 31.

When predetermined hydraulic pressure is supplied to the hydraulic chamber 31, the piston 8 is shifted to the left in FIG. 1, thereby tightening the wet type multi-plate clutch 30 between the piston and the backing plate 19.

The friction plate 3 of the wet type multi-plate clutch 30 is provided with grooves (not shown) communicating between an inner diameter side and an outer diameter side, and each groove is formed to have a depth substantially the same as a thickness of the friction material 35 and a circumferential width greater than 3 mm. With this arrangement, a cooling effect is enhanced even in the engagement condition of the starting clutch 10 which is hard to be cooled. Further, according to the present invention, since the lubricant oil is always supplied with the flow amount smaller than that during the idle rotation so as to cool the clutch even during the engagement thereof, the cooling efficiency is further enhanced. This is the reason why, since the lubricant oil is always flown in accordance with the temperature of the starting clutch, the adequate cooling can be achieved even if the engagement and disengagement of the clutch are repeated frequently.

A hub member 2 fitted on an input shaft 16 to be rotated integrally with the input shaft 16 of the transmission is provided at its outer periphery with a spline portion 36. The friction plates 3 are mounted to the spline portion 36 for an axial sliding movement. Accordingly, a power inputted from a crank shaft (not shown) is transmitted to the transmission (not shown) via a housing 12 through a damper device 14, clutch case 1, wet type multi-plate clutch 30, hub member 2 and input shaft 16.

The clutch case 1 of the wet type multi-plate clutch 30 is provided with the above-mentioned damper device 14 as a shock absorbing mechanism for absorbing shock generated upon the engagement of the clutch. The damper device 14 includes a spring and a retainer plate for holding the spring.

An axial one end of the input shaft 16 is provided at its outer periphery with a spline portion into which the hub member 2 is fitted. Accordingly, the input shaft 16 and the hub member 2 are rotated integrally with each other.

A cover member 7 is provided at an open end portion of the clutch case 1. An outer diameter portion of the cover member 7 is fitted in a spline portion 39 of the clutch case 1. Thus, the cover member 7 is rotated together with the clutch case 1. A narrow lubricant oil passage 40 is defined between the cover member 7 and the hub member 2. As can be seen from FIG. 1, by providing the cover member 7, the wet type multi-plate clutch 30 is disposed in a substantially closed space.

Now, an oil path for supplying the oil to the hydraulic chamber 31 of the wet type multi-plate clutch 30 will be explained. The oil to be supplied to the hydraulic chamber 31 to urge the piston 8 of the wet type multi-plate clutch 30 is controlled by an oil pump (not shown) and a hydraulic control device (not shown).

The oil is supplied from a hydraulic pressure supplying source (not shown) to the hydraulic chamber 31 through a passage provided in the input shaft 16, a passage 32 between the input shaft 16 and the clutch case 1 and a passage 33 of the clutch case 1.

Now, an oil path for the lubricant oil lubricating the wet type multi-plate clutch 30 will be explained. The lubricant oil for lubricating the wet type multi-plate clutch 30 is controlled by an oil pump (not shown) and a flow amount control valve 63 connected to a lubrication controlling apparatus 70.

The lubrication controlling apparatus 70 comprises a first temperature sensor 62 for detecting a temperature of oil in the starting clutch 10, and a flow amount control valve 63 as control means for controlling a flow amount of the lubricant oil of the starting clutch 10 in accordance with the oil temperature detected by the first temperature sensor 62, regardless of a running condition of a vehicle (not shown). In this lubrication controlling apparatus 70, the supplying path for supplying the hydraulic pressure to the hydraulic chamber 31 is provided as a separate route. By the detected result of the first temperature sensor, if it is judged that the heat generated in the starting clutch 10 is great, a much amount of lubricant oil is flown.

The lubricant oil is supplied to the flow amount control valve 63 through a lubricant oil supplying path 72 connected to a lubricant oil supplying source (not shown). The lubricant oil is supplied from the flow amount control valve 63 to the starting clutch 10 via an oil path 71. As will be described later, a controller 61 serves to treat temperature detection information from two temperature sensors 62 and 64 so that the flow amount from the flow amount control valve 63 is controlled on the basis of the detected temperatures. An oil outlet through which the lubricant oil is returned to a transmission (not shown) is provided at a portion of the housing 12, which is opposed to the transmission.

The flow amount control valve 63 of the lubrication controlling apparatus 70 controls the flow amount of the lubricant oil in such a manner that, if the temperature of the oil in the starting clutch 10 is below a first set value, the flow amount is minimized, and, if the temperature of the oil is above a second set value, the flow amount is maximized, and, if the temperature of the oil is between the first and second set values, the flow amount is continuously changed in accordance with the temperature of the oil. Further, the flow amount control valve 63 also controls the amount of the lubricant oil electrically so that the lubricant oil is always flown into the starting clutch 10.

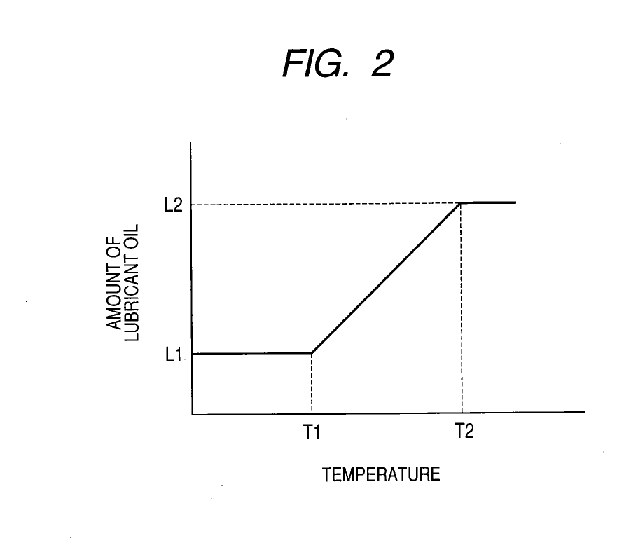

As shown in FIG. 2, the first temperature sensor 62 is positioned at a lower end of the starting clutch 10. This position is a position where a temperature of oil scattered from the starting clutch 10 can be detected. As a result, the oil temperature of the lubricant oil in the starting clutch 10 can be detected accurately.

The lubrication controlling apparatus 70 may include means for storing the oil scattered from the starting clutch 10. The storing means may be, for example, a recessed portion formed in a lower portion 13 of the housing 12 in the vicinity of the temperature sensor 62. With this arrangement, since the first temperature sensor 62 detects the oil temperature of the lubricant oil stored in the storing means, the detection result becomes more accurate and is stabilized.

The lubrication controlling apparatus 70 further includes a second temperature sensor 64 for detecting a temperature of oil in the transmission, and the flow amount control valve 63 causes the controller 61 to control the flow amount of the lubricant oil of the starting clutch 10 in accordance with a difference between the temperature detected by the first temperature sensor 62 and the temperature detected by the second temperature sensor 64. By doing so, the flow amount of the lubricant oil can be controlled more accurately.

Now, the lubrication control of the present invention will be explained with reference to FIG. 2. FIG. 2 is a graph showing the temperature and the amount of the lubricant oil in the starting clutch.

As shown in FIG. 2, the control is performed in such a manner that, if the oil temperature of the lubricant oil detected by the temperature sensor 62 is below an oil temperature T1 (first set temperature), the amount of the lubricant oil becomes substantially constant at a minimum value L1 and, if the oil temperature is above an oil temperature T2 (second set value), the amount of the lubricant oil becomes substantially constant at a maximum value L2. Further, a condition that the amount of the lubricant oil is the minimum value L1 corresponds to a fully tightened condition of the starting clutch 10, and a condition that the amount of the lubricant oil is the maximum value L2 corresponds to an idle rotation condition of the starting clutch 10.

In FIG. 2, in an inclined line area, i.e. between the first set temperature T1 and the second set value T2, the control is performed in such a manner that the flow amount of the lubricant oil is changed continuously in accordance with the oil temperature.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-136931 filed May 23, 2007, which is hereby incorporated by reference in its entirety.

What is claimed is:

1. A lubrication controlling method for a starting clutch disposed between a transmission and an engine of a vehicle and having a wet type multi-plate clutch for transmitting a power, comprising the steps of:
detecting a temperature of oil in said starting clutch by means of a first temperature sensor; and
controlling a flow amount of lubricant oil of said starting clutch in accordance with the temperature of the oil detected by said first temperature sensor, regardless of a running condition of said vehicle; and wherein
said controlling step is performed in such a manner that, if the temperature of the oil is below a first set value, the flow amount is minimized, and, if the temperature of the oil is above a second set value, the flow amount is maximized, and if the temperature of the oil is between said first and second set values, the flow amount of the lubricant oil is changed continuously in accordance with the temperature of the oil.

2. A lubrication controlling method for a starting clutch according to claim 1, wherein, in said controlling step, the flow amount of the lubricant oil of said starting clutch is controlled electrically.

3. A lubrication controlling method for a starting clutch according to claim 1, wherein, in said controlling step, a temperature of oil in said transmission is detected by a second temperature sensor, and, in said controlling step, the flow amount of the lubricant oil of said starting clutch is controlled in accordance with a difference between the temperature of the oil detected by said first temperature sensor and the temperature of the oil detected by said second temperature sensor.

4. A lubrication controlling method for a starting clutch according to claim 2, wherein said first temperature sensor detects the temperature of the oil at a position where a temperature of oil scattered from said starting clutch is detected.

5. A lubrication controlling method for a starting clutch according to claim 4, wherein, in said controlling step, the oil scattered from said starting clutch is stored, and a temperature of the oil stored is detected by said first temperature sensor.

6. A lubrication controlling method for a starting clutch according to claim 1, wherein said wet type multi-plate clutch includes a plurality of friction plates each formed by sticking a friction material to a core plate, and a groove communicating from an inner diameter side to an outer diameter side is formed in said friction plate, and said groove has a thickness substantially the same as a thickness of said friction material and a circumferential width greater than 3 mm.

7. A lubrication controlling apparatus for a starting clutch disposed between a transmission and an engine of a vehicle and having a wet type multi-plate clutch for transmitting a power, comprising:
a first temperature sensor for detecting a temperature of oil in said starting clutch; and
control means for controlling a flow amount of lubricant oil of said starting clutch in accordance with the temperature of the oil detected by said first temperature sensor, regardless of a running condition of said vehicle; and wherein
said control means performs the control in such a manner that, if the temperature of the oil is below a first set value, the flow amount is minimized, and, if the temperature of the oil is above a second set value, the flow amount is maximized, and if the temperature of the oil is between said first and second set values, the flow amount of the lubricant oil is changed continuously in accordance with the temperature of the oil.

8. A lubrication controlling apparatus for a starting clutch according to claim 7, wherein said control means control the flow amount of the lubricant oil of said starting clutch electrically.

9. A lubrication controlling apparatus for a starting clutch according to claim 7, wherein said controlling apparatus further include a second temperature sensor for detecting a temperature of oil in said transmission, and said control means controls the flow amount of the lubricant oil of said starting clutch in accordance with a difference between the temperature of the oil detected by said first temperature sensor and the temperature of the oil detected by said second temperature sensor.

10. A lubrication controlling apparatus for a starting clutch according to claim 7, wherein said first temperature sensor is positioned at a position where a temperature of oil scattered from said starting clutch is detected.

11. A lubrication controlling apparatus for a starting clutch according to claim 10, wherein said controlling apparatus further includes storing means for storing the oil scattered from said starting clutch.

12. A lubrication controlling apparatus for a starting clutch according to claim 11, wherein said first temperature sensor detect a temperature of the oil stored in said storing means.

13. A lubrication controlling apparatus for a starting clutch according to claim 7, wherein said wet type multi-plate clutch includes a plurality of friction plates each formed by sticking a friction material to a core plate, and a groove communicating from an inner diameter side to an outer diameter side is formed in said friction plate, and said groove has a thickness substantially the same as a thickness of said friction material and a circumferential width greater than 3 mm.
